(19) United States
(12) Patent Application Publication
(10) Pub. No.: US 2015/0193883 A1
(43) Pub. Date: Jul. 9, 2015

(54) SYSTEMS AND METHODS FOR AGGREGATING AND ANALYZING ATTRIBUTES FOR HABITATIONAL INSURANCE POLICIES

(71) Applicant: Trans Union LLC, Chicago, IL (US)

(72) Inventors: Anthony Sullins, Dacula, GA (US); Clifton H. Burns, Geneva, IL (US); Jeffrey Martin, Streamwood, IL (US)

(21) Appl. No.: 14/538,747

(22) Filed: Nov. 11, 2014

Related U.S. Application Data
(60) Provisional application No. 61/902,613, filed on Nov. 11, 2013.

(51) Int. Cl. G06Q 40/08

(52) U.S. Cl. CPC G06Q 40/08

(57) ABSTRACT

Systems and methods are provided for depersonalizing and aggregating insurance-related attributes for individuals of a multi-unit complex into aggregated insurance-related data, based on received data, and analyzing the aggregated insurance-related data. Data for a multi-unit complex may be received from an insurance carrier or other entity. Insurance-related attributes for individuals of the multi-unit complex may be retrieved from an insurance data database, based on the received data. The insurance-related attributes may be depersonalized and aggregated to generate insurance-related data. The aggregated insurance-related data may be analyzed to generate analytic data, which can be transmitted to the insurance carrier or other entity. Insurance carriers can use the analytic data to obtain more accurate risk assessments for multi-unit complexes so that the insurance carriers can provide improved and more optimal pricing for habitational insurance policies. Financial institutions can use the analytic data to improve commercial lending underwriting.

### CROSS-REFERENCE TO RELATED APPLICATION

This application claims the benefit of U.S. Provisional Patent Application No. 61/902,613 filed on Nov. 11, 2013, which is incorporated herein by reference in its entirety.

### TECHNICAL FIELD

This invention relates to systems and methods for aggregating and analyzing attributes for habitational insurance policies. More particularly, the invention provides systems and methods for depersonalizing and aggregating insurance-related attributes for individuals of a multi-unit complex into aggregated insurance-related data, and analyzing the aggregated insurance-related data.

### BACKGROUND OF THE INVENTION

Multi-unit complexes, such as apartment buildings, condominium buildings, collections of rental single family homes, and/or other types of multi-unit complexes, typically have insurance to provide protection against risks to the complexes, including fire, vandalism, liability losses, and the like. Such insurance is often called habitational insurance, and can have unique and different risk factors as compared to other types of insurance, e.g., homeowner's insurance. For example, non-weather losses for multi-unit complexes generally make up a higher percentage of total losses than for single family homes. As another example, liability and fire losses for multi-unit complexes generally make up a higher percentage of losses than for single family homes.

Insurance carriers that underwrite habitational insurance policies typically price the policies using similar rating attributes as for other types of insurance. The rating attributes may include the credit rating of the owner, replacement cost, construction type, geography, age of the building(s), prior losses, etc. However, unlike other types of buildings, many individuals may reside in a multi-unit complex. Current pricing of habitational insurance policies typically does not take into account the risk factors of these individuals. Such risk factors can include the credit rating of the individuals, occupancy trends of the multi-unit complex, velocity and turnover of the individuals in the multi-unit complex, etc. Because risk factors of the individuals are not taken into account, aspects of the pricing of habitational insurance policies can be discretionary. Accordingly, the pricing of habitational insurance policies may not be optimal because insurance carriers cannot factor in the risk factors of the individuals of the multi-unit complexes.

Financial institutions that underwrite commercial loans may also base lending decisions, interest rates, and/or other parameters based on the credit rating of the owner, replacement cost, construction type, geography, age of the building(s), prior losses, etc. Again, because many individuals reside in a multi-unit complex, current underwriting of commercial loans typically does not take into account the risk factors of these individuals. As such, the underwriting of commercial loans related to multi-unit complexes may not be optimal.

Therefore, there exists an opportunity for systems and methods that can acquire, depersonalize, and aggregate insurance-related attributes for individuals of a multi-unit complex, and analyze the aggregated insurance-related data for improved risk assessment, in order to, among other things, assist insurance carriers in obtaining improved and more accurate pricing for habitational insurance policies, and assist financial institutions in improving underwriting of commercial loans.

### SUMMARY OF THE INVENTION

The invention is intended to solve the above-noted problems by providing systems and methods for analyzing aggregated insurance-related data by retrieving, depersonalizing, and aggregating insurance-related attributes for individuals of a multi-unit complex. The systems and methods are designed to, among other things: (1) receive data for a multi-unit complex; (2) retrieve insurance-related attributes for individuals of the multi-unit complex, based on the received data; (3) depersonalize and aggregate the insurance-related attributes to generate aggregated insurance-related data; and (4) analyze the aggregated insurance-related data to generate analytic data.

In a particular embodiment, insurance policy data for a multi-unit complex may be received from an insurance carrier. The insurance policy data may include at least one address of the multi-unit complex. Insurance-related attributes for individuals of the multi-unit complex may be retrieved from a database, based on the address of the multi-unit complex. The insurance-related attributes may be depersonalized and aggregated to generate aggregated insurance-related data. The aggregated insurance-related data may be analyzed, and analytic data may be generated. The analytic data may be transmitted to the insurance carrier.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system for aggregating and analyzing insurance-related attributes of individuals of a multi-unit complex.

FIG. 2 is a flowchart illustrating operations for aggregating and analyzing insurance-related attributes of individuals of a multi-unit complex using the system of FIG. 1.

FIG. 3 is a block diagram of one form of a computer or server of FIG. 1, having a memory element with a computer readable medium for implementing the system for aggregating and analyzing insurance-related attributes of individuals of a multi-unit complex.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

It should also be noted that the disclosures made in this specification are in accordance with the principles of the embodiments(s), which are intended to be disclosed or interpreted to their broadest extent under the patent laws, and while such disclosure may describe or otherwise cover subject matter that may be regulated by other existing laws or regulations, including, without limitation, the Fair Credit Reporting Act (FCRA) or the Equal Credit Opportunity Act (ECOA), nothing in this disclosure is intended to suggest or imply noncompliance with any such law or regulation by the assignee.

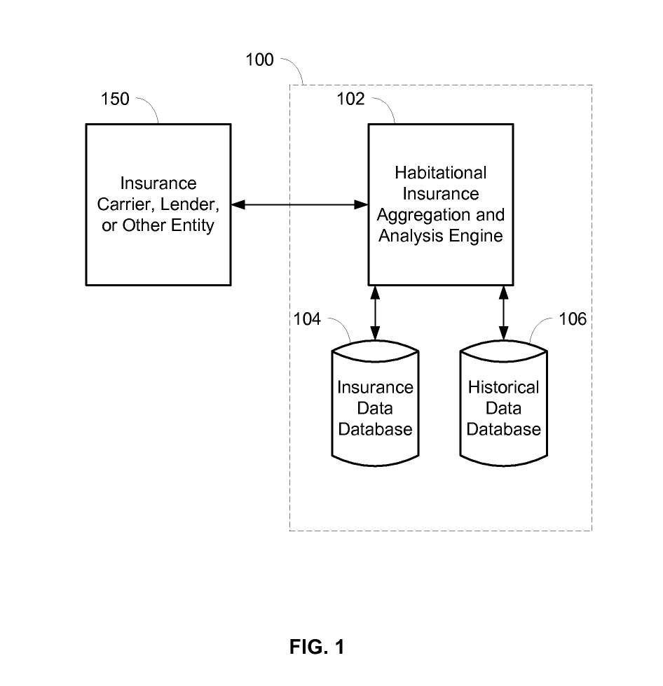

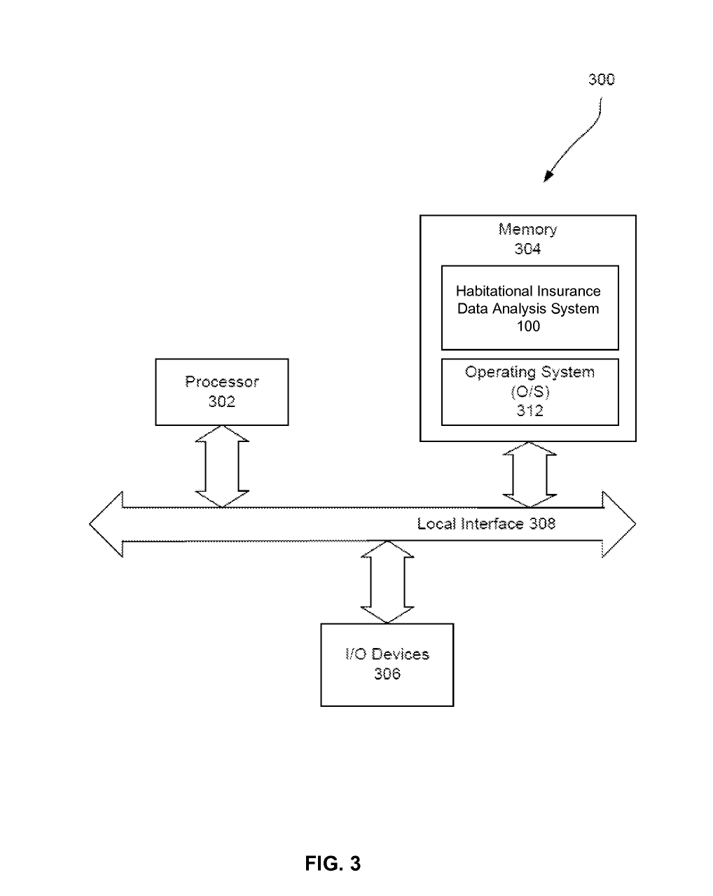

FIG. 1 illustrates a habitational insurance data analysis system 100 for aggregating and analyzing insurance-related attributes of individuals of a multi-unit complex, in accordance with one or more principles of the invention. The system 100 may receive insurance policy data, lending data, or other data for a multi-unit complex from an insurance carrier, lender, or other entity 150; retrieve insurance-related attributes for individuals of the multi-unit complex from an insurance data database 104, based on the received data; depersonalize and aggregate the insurance-related attributes to generate insurance-related data; analyze the aggregated insurance-related data; and generate and transmit analytic data to the entity 150, based on the analysis. Accordingly, insurance carriers can use the analytic data to obtain more accurate risk assessments for multi-unit complexes so that the insurance carriers can provide improved and more optimal pricing for habitational insurance policies. Various components of the system 100 may be implemented using software executable by one or more servers or computers, such as a computing device 300 with a processor 302 and memory 304 as shown in FIG. 3, which is described in more detail below.

In an embodiment, a habitational insurance aggregation and analysis engine 102 in the system 100 may receive insurance policy data from an insurance carrier 150. The insurance policy data may be related to a habitational insurance policy for a multi-unit complex. For example, an owner, management company, condominium board, and/or landlord of the multi-unit complex may have requested a quote from the insurance carrier 150 for a habitational insurance policy for the complex. In turn, the insurance carrier 150 may desire to obtain greater information about the complex and the individuals residing in the complex, in order to provide a more accurate quote.

The insurance policy data may include one or more addresses of the multi-unit complex, a policy name, a policy identification number, a name of the multi-unit complex, a type of the multi-unit complex (e.g., apartment building, apartment complex, condominium building, collection of single family homes, etc.), a total number of units of the multi-unit complex, and/or other data. In particular, the addresses of the multi-unit complex may include, for example, a single address as in the case of a high-rise apartment or condominium building, or multiple addresses as in the case of multiple buildings that make up a large apartment complex or collection of rentable single family homes. The addresses can include a street number, direction, street name, city/town, state, zip code, and/or other geographical address information.

Based on the data received from the entity 150, the habitational insurance aggregation and analysis engine 102 may retrieve insurance-related attributes for individuals of the multi-unit complex from an insurance data database 104. In particular, the engine 102 can utilize the address(es) of the multi-unit complex to determine the individuals who reside in the multi-unit complex. The address(es) in the received data can be compared to addresses in the insurance data database 104, and the individuals who reside at the address(es) can be identified. The insurance-related attributes for the individuals at the address(es) can then be retrieved from the insurance data database 104. The insurance data database 104 does not include data collected from the entity 150, e.g., the insurance carrier, but instead includes insurance-related attributes that have been derived from other data, such as credit-related data, by processing such other data through insurance risk models, for example.

The insurance-related attributes may include one or more insurance scores for the individuals, an initial habitation date of the individuals at the multi-unit complex, ages of the individuals, and/or other attributes. The insurance scores may be a numerical approximation of the aggregate risk associated with the individuals, i.e., the risk of the individuals making an insurance claim associated with automobiles, property, etc. The initial habitation date of an individual at the multi-unit complex may include the date (e.g., month and year) when the individual began to reside at the multi-unit complex. In some embodiments, the insurance-related attributes, such as the insurance scores, may have been calculated and/or derived from credit-related data associated with the individual. The credit-related data may have been stored in a credit data database (not shown) or other database. In some embodiments, the insurance-related attributes can be calculated on a real-time basis, i.e., after the insurance policy data has been received, and in other embodiments, the insurance-related attributes may be periodically calculated and stored in the insurance data database 104, e.g., quarterly, monthly, weekly, etc. The habitational insurance aggregation and analysis engine 102 and/or other components (not shown) may perform the calculation and/or derivation of the insurance-related attributes.

After retrieving the insurance-related attributes for the individuals of the multi-unit complex, the habitational insurance aggregation and analysis engine 102 may depersonalize and aggregate the insurance-related attributes to generate aggregated insurance-related data. The depersonalization of the insurance-related attributes ensures that the aggregated insurance-related data will not include identifying information of the individuals. In some embodiments, the aggregated insurance-related data may be organized on a periodic basis, e.g., monthly. The aggregated insurance-related data may include, for example, a total count of the individuals at a multi-unit complex, average and median insurance scores of the individuals, categorization and counts of individuals at different risk levels, calculation of the average age of the individuals, categorization and counts of the individuals at different age levels, categorization and counts of individuals by length of time resided at the multi-unit complex, and/or other types of data.

In particular, the different risk levels for the categorization and counts of individuals may include several risk levels that are based on the insurance scores of the individuals. For example, the risk levels may include superior, high, medium, low, and poor, where each risk level is defined by a particular range of insurance scores. Similarly, the different age levels for the categorization and counts of the individuals may include several age levels that are based on the ages of the individuals. For example, the age levels may each be defined by a particular age range, e.g., 25 years old or lower, between 26 and 39 years old, between 40 and 59 years old, and 60 years old or greater. The categorization and counts of individuals by length of time resided at the multi-unit complex may include several retention levels that are based on the residence duration of the individuals at the multi-unit complex. For example, the retention levels may each be defined by a different duration, e.g., less than 12 months, 12 months or greater, 24 months or greater, and 36 months or greater.

The aggregated insurance-related data may be analyzed by the habitational insurance aggregation and analysis engine 102 and analytic data may be generated based on the analysis. The analytic data may be transmitted in a text format, XML format, and/or other appropriate format, for example, to the insurance carrier 150 and/or other entities. In some embodiments, the analytic data may be stored in a historical data database 106. The analytic data may include statistics regarding the insurance scores of the individuals, the ages of the individuals, retention data, velocity data, and/or other types of data. In particular, regarding the insurance scores of the individuals, the aggregated insurance-related data can be analyzed to determine aggregate scores at a policy level, an address level, a complex level, and/or unit level; trends over a period, e.g., month to month; the number of units that have more than a predetermined threshold of individuals; average and median scores (that may or may not be weighted); changes in scores over time; distribution and percentages of scores in different risk levels; comparative ratios of different risk levels (e.g., poor to superior ratio); changes in the comparative ratios; and/or other types of analyses. The aggregated insurance-related data related to the ages of the individuals can be analyzed to determine average ages over time; distribution and percentages of ages over time; and/or other types of analyses.

Regarding retention data, the aggregated insurance-related data can be analyzed to determine the distribution and percentages of the residence duration of individuals over time; comparative ratios of different retention levels (e.g., short term to long term); and/or other types of analyses. With regards to velocity data, the aggregated insurance-related data can be analyzed to determine the count of individuals that are new to the multi-unit complex (e.g., individuals who have only resided in a current month), the count of individuals that continue to reside at the multi-unit complex (e.g., individuals who resided in a prior month and a current month), the count of individuals that no longer reside at the multi-unit complex (e.g., individuals who only resided in a prior month), and/or other types of analyses.

The analytic data may be utilized by the insurance carrier 150, for example, to improve the pricing for the habitational insurance policy for the multi-unit complex. For example, the retention data and velocity data may be helpful in measuring the stability of the multi-unit complex, i.e., the change rates of the individuals. The retention data measures the length of time the individual has resided at the multi-unit complex. As such, a retention rate of 100% would indicate that all individuals have resided at the multi-unit complex for a given time period. The velocity data measures the total change in the number of individuals associated with the multi-unit complex over a time period. If the velocity data is divided by the total number of units of the multi-unit complex to generate a velocity score, then a velocity score of 0 would indicate no movement. In addition, a higher velocity score would indicate a higher number of transient individuals in the multi-unit complex.

The analytic data may also be utilized to gain insight into other aspects related to the multi-unit complex. For example, the stability of the individuals, i.e., more or less movement, at the multi-unit complex may indicate the quality of the management policies and the satisfaction of the individuals with the quality of the complex. The stability of the individuals may also indicate the quality of the risk selection of the individuals. A higher stability may indicate that the individuals are more responsible and have lower loss potential, while a lower stability may indicate that the individuals are transient with higher loss potential. A lower turnover rate may indicate that future claims and losses may be lessened. In contrast, a higher turnover rate may indicate that future claims and losses may be increased. Higher turnover rate may also lead to revenue or income loss that could result in fraud, and to more frequent loss control inspections.

In some embodiments, the insurance-related attributes and/or the analytic data may be utilized in determining metrics for the multi-unit complex that can be provided to the insurance carrier 150 and/or other entities, such as financial institutions. The metrics can be used to quickly see the risk for a multi-unit complex. The metrics can also be used for improving the pricing for the habitational insurance policy for the multi-unit complex. For example, metrics can be defined for best in class risk, superior risk, preferred risk, standard risk, average risk, and non-standard risk. These different metrics can be defined based on different combinations of risk levels of insurance scores, ages, distributions, trends, and/or other data. For example, the best in class risk metric for a multi-unit complex may include when the average insurance score for the individuals is at a superior risk level, the poor to superior ratio is low, there is a high percentage of individuals over a certain age, there is lower turnover, and there is a lower short term to long term ratio. In contrast, the non-standard risk for a multi-unit complex may include when the average insurance score for the individuals is at a low or poor risk level, the poor to superior ratio is high, there is a low percentage of individuals over a certain age, there is higher turnover, and there is a higher short term to long term ratio.

In embodiments, the system 100 may receive other types of data, such as commercial lending data, from a lender, e.g., financial institution 150. The lending data may be received by the habitational insurance aggregation and analysis engine 102, and be related to a commercial loan or other financial instrument for a multi-unit complex. The lending data may include one or more addresses of the multi-unit complex, a loan identification number, loan parameters, an insurance policy name, an insurance policy identification number, a name of the multi-unit complex, a type of the multi-unit complex (e.g., apartment building, apartment complex, condominium building, collection of single family homes, etc.), a total number of units of the multi-unit complex, and/or other data.

Based on the commercial lending data, the system 100 may retrieve insurance-related attributes for individuals of the multi-unit complex from an insurance data database 104. In particular, the engine 102 can utilize the address(es) of the multi-unit complex to determine the individuals who reside in the multi-unit complex. The address(es) in the lending data can be compared to addresses in the insurance data database 104, and the individuals who reside at the address(es) can be identified. The insurance-related attributes for the individuals at the address(es) can then be retrieved from the insurance data database 104. As described above, the system 100 can depersonalize and aggregate the insurance-related attributes to generate insurance-related data; analyze the aggregated insurance-related data; and generate and transmit analytic data to the financial institution, based on the analysis. In this embodiment, the financial institution can use the analytic data to obtain more accurate risk assessments for multi-unit complexes so that the financial institution can perform more optimal underwriting of commercial loans, for example.

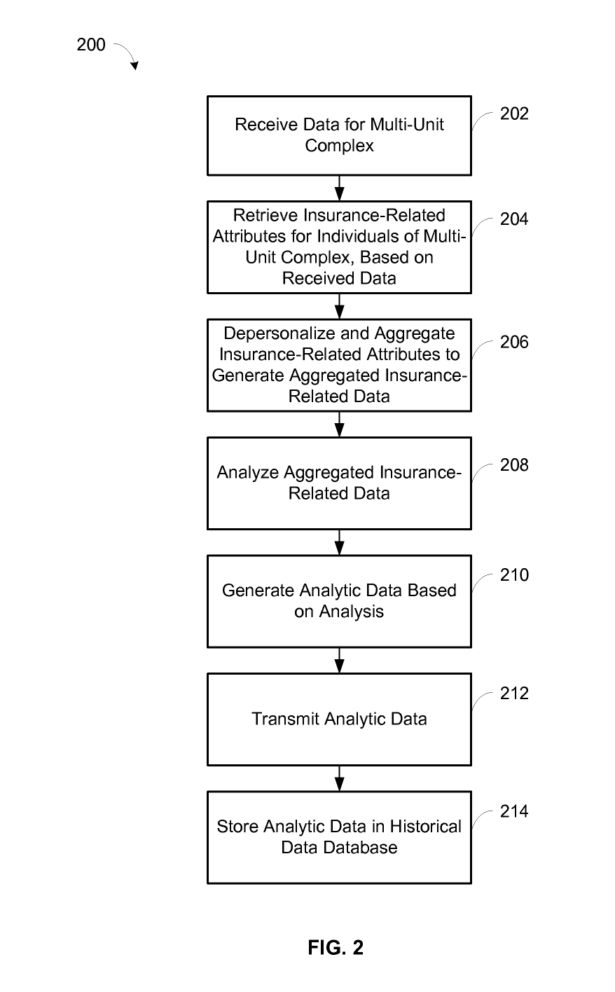

An embodiment of a process 200 for aggregating and analyzing insurance-related attributes of individuals of a multi-unit complex is shown in FIG. 2, in accordance with one or more principles of the invention. The process 200 can result in receiving insurance policy data, lending data, or other pertinent data for a multi-unit complex from an insurance carrier, retrieving insurance-related attributes for individuals of the multi-unit complex from an insurance data database, based on the received data; depersonalizing and aggregating the insurance-related attributes to generate insurance-related data; analyzing the aggregated insurance-related data; and generating and transmitting analytic data to the insurance carrier, based on the analysis. Insurance carriers can use the analytic data to obtain more accurate risk assessments for multi-unit complexes so that the insurance carriers can provide improved and more optimal pricing for habitational insurance policies.

At step 202, insurance policy data related to a habitational insurance policy for a multi-unit complex may be received from an insurance carrier. As described above, lending data or other types of data may also be received from a financial institution, for example, at step 202. The insurance policy data, lending data, or other data may include one or more addresses of the multi-unit complex, a policy name, a policy identification number, a name of the multi-unit complex, a type of the multi-unit complex (e.g., apartment building, apartment complex, condominium building, collection of single family homes, etc.), a total number of units of the multi-unit complex, and/or other data. In particular, the addresses of the multi-unit complex may include, for example, a single address as in the case of a high-rise apartment or condominium building, or multiple addresses as in the case of multiple buildings that make up a large apartment complex or collection of rentable single family homes. The addresses can include a street number, direction, street name, city/town, state, zip code, and/or other geographical address information.

Insurance-related attributes for individuals of the multi-unit complex may be retrieved at step 204 from an insurance data database, based on the insurance policy data, lending data, or other data. In embodiments, the address(es) of the multi-unit complex can be used to determine the individuals who reside in the multi-unit complex. The address(es) in the insurance policy data, lending data, or other data can be compared to addresses in the insurance data database, and the individuals who reside at the address(es) can be identified. The insurance-related attributes for the individuals at the address(es) can then be retrieved from the insurance data database. The insurance-related attributes may include one or more insurance scores for the individuals, an initial habitation date of the individuals at the multi-unit complex, ages of the individuals, and/or other attributes.

At step 206, the insurance-related attributes may be depersonalized and aggregated to generate aggregated insurance-related data. The depersonalization of the insurance-related attributes ensures that the aggregated insurance-related data will not include identifying information of the individuals. The aggregated insurance-related data may include, for example, a total count of the individuals at a multi-unit complex, average and median insurance scores of the individuals, categorization and counts of individuals at different risk levels, calculation of the average age of the individuals, categorization and counts of the individuals at different age levels, categorization and counts of individuals by length of time resided at the multi-unit complex, and/or other types of data.

The aggregated insurance-related data may be analyzed at step 208, and analytic data may be generated at step 210 based on the analysis. The analytic data may be transmitted at step 212 to an insurance carrier, lender, and/or other entities. At step 214, the analytic data may also be stored in a historical data database. The analytic data may include statistics regarding the insurance scores of the individuals, the ages of the individuals, retention data, velocity data, and/or other types of data. In particular, regarding the insurance scores of the individuals, the aggregated insurance-related data can be analyzed at step 208 to determine aggregate scores at a policy level, an address level, a complex level, and/or unit level; trends over a period, e.g., month to month; the number of units that have more than a predetermined threshold of individuals; average and median scores (that may or may not be weighted); changes in scores over time; distribution and percentages of scores in different risk levels; comparative ratios of different risk levels (e.g., poor to superior ratio); changes in the comparative ratios; and/or other types of analyses. The aggregated insurance-related data related to the ages of the individuals can be analyzed at step 208 to determine average ages over time; distribution and percentages of ages over time; and/or other types of analyses.

Regarding retention data, the aggregated insurance-related data can be analyzed at step 208 to determine the distribution and percentages of the residence duration of individuals over time; comparative ratios of different retention levels (e.g., short term to long term); and/or other types of analyses. With regards to velocity data, the aggregated insurance-related data can be analyzed at step 208 to determine the count of individuals that are new to the multi-unit complex (e.g., individuals who have only resided in a current month), the count of individuals that continue to reside at the multi-unit complex (e.g., individuals who resided in a prior month and a current month), the count of individuals that no longer reside at the multi-unit complex (e.g., individuals who only resided in a prior month), and/or other types of analyses.

FIG. 3 is a block diagram of a computing device 300 housing executable software used to facilitate the habitational insurance data analysis system 100. One or more instances of the computing device 300 may be utilized to implement any, some, or all of the components in the system 100, including the habitational insurance aggregation and analysis engine 102. Computing device 300 includes a memory element 304. Memory element 304 may include a computer readable medium for implementing the system 100, and for implementing particular system transactions. Memory element 304 may also be utilized to implement the insurance data database 104 and the historical data database 106. Computing device 300 also contains executable software, some of which may or may not be unique to the system 100.

In some embodiments, the system 100 is implemented in software, as an executable program, and is executed by one or more special or general purpose digital computer(s), such as a mainframe computer, a personal computer (desktop, laptop or otherwise), personal digital assistant, or other handheld computing device. Therefore, computing device 300 may be representative of any computer in which the system 100 resides or partially resides.

Generally, in terms of hardware architecture as shown in FIG. 3, computing device 300 includes a processor 302, a memory 304, and one or more input and/or output (I/O) devices 306 (or peripherals) that are communicatively coupled via a local interface 308. Local interface 308 may be one or more buses or other wired or wireless connections, as is known in the art. Local interface 308 may have additional elements, which are omitted for simplicity, such as controllers, buffers (caches), drivers, transmitters, and receivers to facilitate external communications with other like or dissimilar computing devices. Further, local interface 308 may include address, control, and/or data connections to enable internal communications among the other computer components.

Processor 302 is a hardware device for executing software, particularly software stored in memory 304. Processor 302 can be any custom made or commercially available processor, such as, for example, a Core series or vPro processor made by Intel Corporation, or a Phenom, Athlon or Sempron processor made by Advanced Micro Devices, Inc. In the case where computing device 300 is a server, the processor may be, for example, a Xeon or Itanium processor from Intel, or an Opteron-series processor from Advanced Micro Devices, Inc. Processor 302 may also represent multiple parallel or distributed processors working in unison.

Memory 304 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 304 can have a distributed architecture where various components are situated remote from one another, but are still accessed by processor 302. These other components may reside on devices located elsewhere on a network or in a cloud arrangement.

The software in memory 304 may include one or more separate programs. The separate programs comprise ordered listings of executable instructions for implementing logical functions. In the example of FIG. 3, the software in memory 304 may include the system 100 in accordance with the invention, and a suitable operating system (O/S) 312. Examples of suitable commercially available operating systems 312 are Windows operating systems available from Microsoft Corporation, Mac OS X available from Apple Computer, Inc., a Unix operating system from AT&T, or a Unix-derivative such as BSD or Linux. The operating system O/S 312 will depend on the type of computing device 300. For example, if the computing device 300 is a PDA or handheld computer, the operating system 312 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 312 essentially controls the execution of other computer programs, such as the system 100, and provides scheduling, input-output control, file and data management, memory management, and communication control and related services.

If computing device 300 is an IBM PC compatible computer or the like, the software in memory 304 may further include a basic input output system (BIOS). The BIOS is a set of essential software routines that initialize and test hardware at startup, start operating system 312, and support the transfer of data among the hardware devices. The BIOS is stored in ROM so that the BIOS can be executed when computing device 300 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, and Lua. Components of the system 100 may also be written in a proprietary language developed to interact with these known languages.

I/O device 306 may include input devices such as a keyboard, a mouse, a scanner, a microphone, a touch screen, a bar code reader, or an infra-red reader. It may also include output devices such as a printer, a video display, an audio speaker or headphone port or a projector. I/O device 306 may also comprise devices that communicate with inputs or outputs, such as a short-range transceiver (RFID, Bluetooth, etc.), a telephonic interface, a cellular communication port, a router, or other types of network communication equipment. I/O device 306 may be internal to computing device 300, or may be external and connected wirelessly or via connection cable, such as through a universal serial bus port.

When computing device 300 is in operation, processor 302 is configured to execute software stored within memory 304, to communicate data to and from memory 304, and to generally control operations of computing device 300 pursuant to the software. The system 100 and operating system 312, in whole or in part, may be read by processor 302, buffered within processor 302, and then executed.

In the context of this document, a “computer-readable medium” may be any means that can store, communicate, propagate, or transport data objects for use by or in connection with the system 100. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 can be embodied in any type of computer-readable medium for use by or in connection with an instruction execution system or apparatus, such as a computer.

For purposes of connecting to other computing devices, computing device 300 is equipped with network communication equipment and circuitry. In a preferred embodiment, the network communication equipment includes a network card such as an Ethernet card, or a wireless connection card. In a preferred network environment, each of the plurality of computing devices 300 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 300 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for aggregating and analyzing insurance-related attributes for a habitational insurance policy for a multi-unit complex, using a processor, the method comprising:
receiving insurance policy data for the multi-unit complex at the processor from an electronic device associated with an insurance carrier, the insurance policy data comprising at least one address of the multi-unit complex;
retrieving at least one insurance-related attribute for at least one individual of the multi-unit complex from a database, based on the at least one address of the multi-unit complex, using the processor;
depersonalizing and aggregating the at least one insurance-related attribute for the at least one individual, using the processor, to generate aggregated insurance-related data;
analyzing the aggregated insurance-related data, using the processor;
generating analytic data based on analyzing the aggregated insurance-related data, using the processor; and
transmitting the analytic data from the processor to the electronic device associated with the insurance carrier.

2. The method of claim 1, wherein the insurance policy data further comprises one or more of a policy name, a policy identification number, a name of the multi-unit complex, a type of the multi-unit complex, or a total number of units of the multi-unit complex.

3. The method of claim 2, wherein the type of the multi-unit complex comprises one or more of an apartment building, an apartment complex, a condominium building, or a plurality of single family homes.

4. The method of claim 1, wherein the at least one insurance-related attribute comprises one or more of an automobile insurance score, a property insurance score, an initial habitation date of the at least one individual at the multi-unit complex, or an age of the at least one individual.

5. The method of claim 1, further comprising analyzing credit-related data in the database to generate the at least one insurance-related attribute, using the processor.

6. The method of claim 1, wherein depersonalizing and aggregating comprises depersonalizing and aggregating the at least one insurance-related attribute for the at least one individual at a level of the at least one address of the multi-unit complex, using the processor.

7. The method of claim 1, wherein analyzing the aggregated insurance-related data comprises using the processor, one or more of calculating an average insurance score, calculating a median insurance score, categorizing an insurance score based on risk, calculating an average age, calculating retention statistics, or calculating velocity statistics.

8. The method of claim 1, wherein the analytic data comprises one or more of insurance score data, retention data, velocity data, or age data.

9. The method of claim 1, further comprising storing the analytic data in a historical data database, using the processor.

10. A system for aggregating and analyzing insurance-related attributes for a habitational insurance policy for a multi-unit complex, the system comprising:
a processor in communication with a network;
a memory in communication with the processor, the memory for storing:
an insurance data database comprising insurance-related attributes for at least one individual of the multi-unit complex;
an aggregation and analysis engine for:
receiving insurance policy data for the multi-unit complex from an electronic device associated with an insurance carrier, the insurance policy data comprising at least one address of the multi-unit complex;
retrieving at least one insurance-related attribute for at least one individual of the multi-unit complex from the insurance data database, based on the at least one address of the multi-unit complex;
depersonalizing and aggregating the at least one insurance-related attribute for the at least one individual, to generate aggregated insurance-related data;
analyzing the aggregated insurance-related data;
generating analytic data based on analyzing the aggregated insurance-related data; and
transmitting the analytic data to the electronic device associated with the insurance carrier.

11. The system of claim 10, wherein the insurance policy data further comprises one or more of a policy name, a policy identification number, a name of the multi-unit complex, a type of the multi-unit complex, or a total number of units of the multi-unit complex.

12. The system of claim 11, wherein the type of the multi-unit complex comprises one or more of an apartment building, an apartment complex, a condominium building, or a plurality of single family homes.

13. The system of claim 10, wherein the at least one insurance-related attribute comprises one or more of an automobile insurance score, a property insurance score, an initial habitation date of the at least one individual at the multi-unit complex, or an age of the at least one individual.

14. The system of claim 10, wherein the aggregation and analysis engine is further for analyzing credit-related data in the database to generate the at least one insurance-related attribute.

15. The system of claim 10, wherein the aggregation and analysis engine depersonalizes and aggregates by depersonalizing and aggregating the at least one insurance-related attribute for the at least one individual at a level of the at least one address of the multi-unit complex.

16. The system of claim 10, wherein the aggregation and analysis engine analyzes the aggregated insurance-related data by one or more of calculating an average insurance score, calculating a median insurance score, categorizing an insurance score based on risk, calculating an average age, calculating retention statistics, or calculating velocity statistics.

17. The system of claim 10, wherein the analytic data comprises one or more of insurance score data, retention data, velocity data, or age data.

18. The system of claim 10, wherein:
the memory further comprises a historical data database for storing the analytic data; and
the aggregation and analysis engine is further for storing the analytic data in the historical data database.

19. A method for aggregating and analyzing insurance-related attributes for a multi-unit complex, using a processor, the method comprising:
receiving data related to the multi-unit complex at the processor from an electronic device associated with a financial institution, the data comprising at least one address of the multi-unit complex;
retrieving at least one insurance-related attribute for at least one individual of the multi-unit complex from a database, based on the at least one address of the multi-unit complex, using the processor;
depersonalizing and aggregating the at least one insurance-related attribute for the at least one individual, using the processor, to generate aggregated insurance-related data;
analyzing the aggregated insurance-related data, using the processor;
generating analytic data based on analyzing the aggregated insurance-related data, using the processor; and
transmitting the analytic data from the processor to the electronic device associated with the financial institution.

20. The method of claim 19, wherein the lending data further comprises one or more of a loan identification number, parameters of a loan, a policy name, a policy identification number, a name of the multi-unit complex, a type of the multi-unit complex, or a total number of units of the multi-unit complex.
